(19) United States
(12) Patent Application Publication
(10) Pub. No.: US 2008/0319794 A1
(43) Pub. Date: Dec. 25, 2008

(54) HEALTH INFORMATION SERVICES USING PHONE

(76) Inventors: Mark Carlson, Half Moon Bay, CA (US); Edward Katzin, San Francisco, CA (US)

Correspondence Address: TOWNSEND AND TOWNSEND CREW LLP, TWO EMBARCADERO CENTER, 8TH FLOOR, SAN FRANCISCO, CA, 94111, US

(21) Appl. No.: 11/765,581

(22) Filed: Jun. 20, 2007

(51) Int. Cl. G06Q 50/00; H04M 1/66

(52) U.S. Cl. 705/3; 705/2; 455/411

(57) ABSTRACT

A method for storage and access to patient information over a payment processing network is disclosed. One embodiment of the invention includes receiving an authentication response message indicating that a requester is authorized to receive medical information, collecting medical information from various medical institutions via a payment processing network, storing the collected medical information at a central location, and providing specific medical information to the requester from the stored collected medical information.

### CROSS-REFERENCES TO RELATED APPLICATIONS

NOT APPLICABLE

### BACKGROUND

Mistakes caused by incomplete or inaccurate patient information such as drug allergies or blood type cost tens of thousands of lives a year. Accurate and timely access to healthcare records could help healthcare providers avoid making mistakes when treating patients. Medical institutions and related organizations recognize that having patient information available electronically will result in safer treatment, significant cost savings, and more efficient access to patent information. Thus, many organizations have converted paper files to digital files and implemented computer systems for their particular organization.

This may work well for accessing patient information if the patient stays within that organization, but a patient may change organizations because he or she moves or changes healthcare insurance. Also, a patient may use several organizations for his or her healthcare needs. For example, a patient may go to her primary doctor with back pain. The primary doctor may prescribe medication for the back pain and refer her to a specialist who is in a different organization. The patient will fill the prescription at a pharmacy which is typically a separate organization. The doctor may also request blood tests or other lab work which may be done by yet another organization. Once the patient visits the specialist, she may have to remember to list her drug allergies on new forms, bring her lab results and remember past diagnoses from her primary doctor. Or her appointment may be delayed while the specialist requests the various paper or electronic documents from the primary doctor.

If this were an emergency situation this would be an even more serious problem. If a patient has been in a serious accident and is rushed to a hospital emergency room, there is often no time to determine blood type and drug allergies or request this information from the patient's primary doctor. Further, an emergency may occur in a remote location without access to a computer or paper records.

Thus, there is a recognized need for healthcare providers and patients to have access to different patient health services systems to reduce medical errors, improve healthcare quality, lower cost, and enhance the privacy and security of patient information and general medical information from various healthcare institutions and related organizations. Embodiments of the invention address these and other problems individually and collectively.

### BRIEF SUMMARY

Embodiments of the invention are directed to methods, systems, and computer readable media for allowing access to patient records from various medical institutions to be conducted in a secure and efficient manner.

One embodiment of the invention is directed to a method comprising receiving an authentication response message indicating that a requester is authorized to receive medical information, collecting medical information from various medical institutions via a payment processing network, storing the collected medical information at a central location, and providing specific medical information to the requester from the stored collected medical information.

Another embodiment of the invention is directed to a method comprising requesting medical information using a portable consumer device wherein an authentication response message is received indicating that a requester is authorized to receive medical information and the requested medical information is collected from various medical institutions via a payment processing network and stored at a central location, and receiving the medical information wherein the requested medical information is provided from the stored medical information.

Another embodiment of the invention is directed to a method comprising receiving a phone number associated with a request for medical information, dialing the phone number, sending the request for medical information to a request broker, sending authentication information to the request broker, and receiving medical information.

Another embodiment of the invention is directed to a phone comprising a processor, an antenna coupled to the processor, and a computer readable medium coupled to the processor, the computer readable medium comprising code for receiving a phone number associated with a request for medical information, code for dialing the phone number, code for sending the request for medical information to a request broker, code for sending authentication information to the request broker, and code for receiving medical information.

Another embodiment of the invention is directed to a portable consumer device comprising a processor, a computer readable medium coupled to the processor, wherein the computer readable medium comprises code for receiving a phone number associated with a request for medical information, code for dialing the phone number, code for sending the request for medical information to a request broker, code for sending authentication information to the request broker, and code for receiving medical information.

These and other embodiments of the invention are described in further detail below.

### BRIEF DESCRIPTION OF THE DRAWINGS

FIG. 1 shows a block diagram of a system according to an embodiment of the invention.

FIG. 2 shows a block diagram of a portable consumer device according to an embodiment of the invention.

FIG. 3 shows a flowchart illustrating steps in a method according to an embodiment of the invention.

### DETAILED DESCRIPTION

Embodiments of the invention allow users of portable consumer devices to use the portable consumer device to securely and efficiently access a variety of health records at various medical institutions such as hospitals, laboratories, pharmacies, etc., over a payment processing network.

Embodiments of the invention allow a person, such as a person in a remote location or in a medical emergency, an emergency medical technician (EMT), a doctor or nurse, etc., to request medical information using a portable consumer device such as a mobile phone, a personal digital assistant (PDA), or a handheld computer. The request may be for vital medical information in an emergency situation such as blood type, drug allergies, and current medications or it may be for general medical records.

The request for medical information is sent from a portable consumer device to a request broker via a payment processing network such as VisaNet. The request for medical information may be an implicit or explicit request for specific or general medical information. This request can take many different forms. For example, a request may simply be in the form of a dialed telephone number. Dialing a dedicated telephone number associated with the medical information can be an implicit request for the information, as it does not contain an explicit request message. In other embodiments, the request may be embodied by an SMS message, an e-mail, or some other type of message. Such messages may or may not include an explicit request for medical information. For example, sending any text message to a dedicated address may be an implicit request for medical information. Alternatively a text message may be sent which says “request medical information for Joe Smith record no. 12345.” This is an explicit request for medical information.

The request broker authenticates the request to be sure that the request is from a person authorized to access the medical information. The request broker may require the requester to enter a PIN or a password, answer a challenge question (e.g., “What are the last four digits of your social security number?”), or may automatically detect the unique factory-set electronic serial number and telephone number of the phone to match to a particular user or use a GPS system to detect the location of the call to ensure it comes from an approved location. If the requester is authenticated, then the request broker requests the medical information from one or more medical institutions, aggregates all of the responses from the medical institutions, and sends the medical information back to the portable consumer device via the payment processing network. The portable consumer device decrypts any encrypted data and then displays the information on the portable consumer device.

Additional details regarding embodiments of the invention are described below.

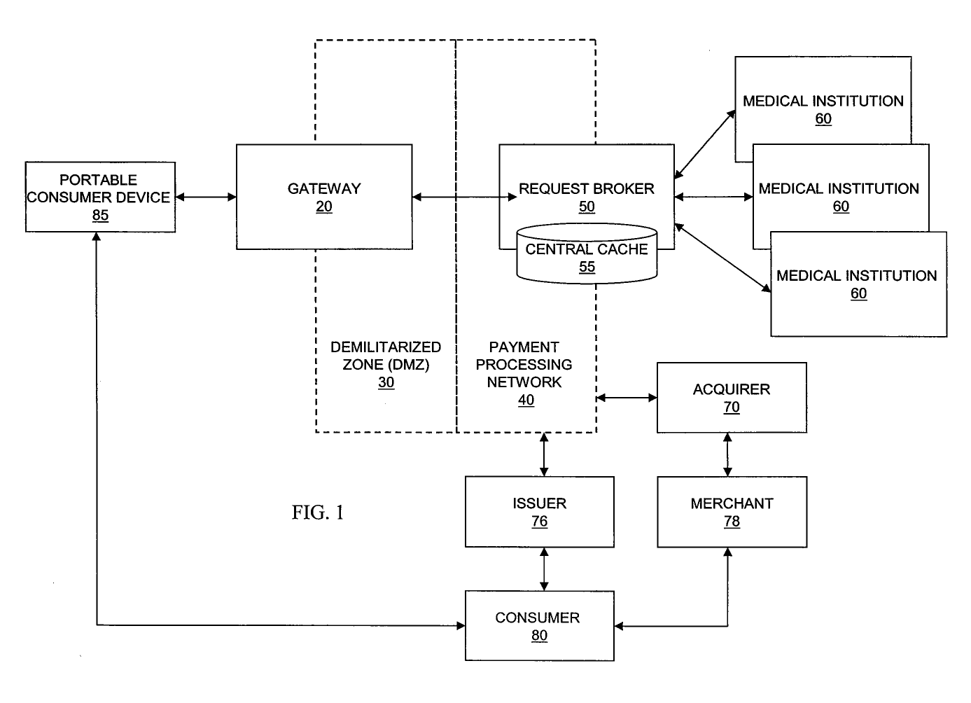

FIG. 1 shows a system that can be used in an embodiment of the invention. For simplicity of illustration, one portable consumer device, one gateway, one request broker, several medical institutions, one issuer, one consumer, one acquirer and one merchant are shown. It is understood, however, that embodiments of the invention may include multiple providers, gateways, request brokers, medical institutions, etc. In addition, some embodiments of the invention may include fewer than all of the components shown in FIG. 1. Also, the components in FIG. 1 may communicate via any suitable communication medium (including the Internet), using any suitable communication protocol.

The system in FIG. 1 includes a portable consumer device 85 associated with the consumer 80. In a typical transaction a consumer 80 may use the portable consumer device 85 to request patient information at one or more medical institutions 60 via a request broker 50 and payment processing network 40. The request broker 50 may be in operative communication with one or more medical institutions 60.

The consumer 80 may be an individual such as a person in an emergency medical situation, patient, doctor, nurse, health administration personnel, pharmacist, insurance carrier, etc., who may use a portable consumer device 85.

The portable consumer device 85 may be in any suitable form. For example, suitable portable consumer devices can be hand-held and compact so that they can fit into a consumer's wallet and/or pocket (e.g., pocket-sized). They may include smart cards, ordinary credit or debit cards (with a magnetic strip and without a microprocessor), keychain devices (such as the Speedpass™ commercially available from Exxon-Mobil Corp.), etc. Other examples of portable consumer devices include cellular and mobile phones, personal digital assistants (PDAs), pagers, handheld computers, payment cards, security cards, access cards, smart media, transponders, and the like. The portable consumer devices can also be debit devices (e.g., a debit card), credit devices (e.g., a credit card), or stored value devices (e.g., a stored value card).

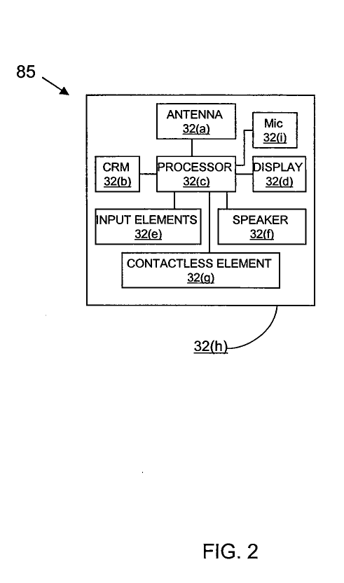

The portable consumer device 85 may comprise a computer readable medium 32(b) and a body 32(h) as shown in FIG. 2. The computer readable medium 32(b) may be present within body 32(h), or may be detachable from it. The body 32(h) may be in the form of a plastic substrate, housing, or other structure. The computer readable medium 32(b) may be a memory that stores data and may be in any suitable form including a magnetic stripe, a memory chip, etc.

If the computer readable medium 32(b) is in a phone, it may comprise code for receiving a phone number and a medical information request from a user of the portable consumer device 85. It may also comprise code for dialing the phone number, code for sending a request for medical information, and code for receiving the medical information.

The portable consumer device 85 may further include a contactless element 32(g), which is typically implemented in the form of a semiconductor chip (or other data storage element) with an associated wireless transfer (e.g., data transmission) element, such as an antenna. Contactless element 32(g) is associated with (e.g., embedded within) portable consumer device 85 and data or control instructions transmitted via a cellular network may be applied to contactless element 32(g) by means of a contactless element interface (not shown). The contactless element interface functions to permit the exchange of data and/or control instructions between the mobile device circuitry (and hence the cellular network) and an optional contactless element 32(g).

Contactless element 32(g) is capable of transferring and receiving data using a near field communications (“NFC”) capability (or near field communications medium) typically in accordance with a standardized protocol or data transfer mechanism (e.g., ISO 14443/NFC). Near field communications capability is a short-range communications capability, such as RFID, Bluetooth™, infra-red, or other data transfer capability that can be used to exchange data between the portable consumer device 85 and a payment processing network 40 or it can be used to exchange data between the portable consumer device 85 and the request broker 50. Thus, the portable consumer device 85 is capable of communicating and transferring data and/or control instructions via both cellular network and near field communications capability.

The portable consumer device 85 may also include a processor 32(c) (e.g., a microprocessor) for processing the functions of the portable consumer device 85 and a display 32(d) to allow a consumer to see phone numbers and other information and messages. The portable consumer device 85 may further include input elements 32(e) to allow a consumer to input information into the device, a speaker 32(f) to allow the consumer to hear voice communication, music, etc., and a microphone 32(i) to allow the consumer to transmit her voice through the portable consumer device 85. The portable consumer device 85 may also include an antenna 32(a) for wireless data transfer (e.g., data transmission).

Returning to FIG. 1, the demilitarized zone (DMZ) 30 may be a network area between the secure payment processing network 40 and another network such as the Internet. The gateway 20 may reside in the DMZ and may be a set of processes and shared libraries that translate requests and responses via a network such as the Internet or a mobile network, to handle connections and delivery of messages to and from the portable consumer device 85.

The request broker 50 may be software or a combination of hardware and software to support message routing, marshalling data, and support for distributed transactions. The request broker 50 may utilize a central cache 55 which may be a data store on the network that provides a collection of data duplicating original data from primary sources such as medical institutions 60. The typical type of data that may be stored in the central cache 55 may include information such as general patient information (e.g., name, address, etc.), patient medical history and records, laboratory results, x-ray results, radiology reports, medical problem lists, prescription information, allergies, blood type, immunization history, clinical notes such as physician and nursing notes about the patient, insurance information and coverage, etc.

The central cache 55 may be populated each time a request is made to the request broker 50 and information is acquired from one or more medical institutions 60. The central cache 55 may also be populated by a batch upload from each medical institution 60 on a regular basis (e.g., daily, weekly, monthly).

The central cache 55 may further provide locality of reference to improve performance and availability. Having a central cache 55 at the request broker 50 rather than just having an index and then a remote cache at each medical institution 60 is less expensive, faster, more reliable, and is better for security and privacy purposes. It is less expensive because the equipment and storage space for the central cache 55 only needs to be available at the central location versus having the equipment and space and each and every medical institution 60. It is faster and more reliable because accessing the cached copy rather than re-fetching the original data reduces the average access time to acquire the data. It is better for security and privacy purposes because security only needs to be implemented in a central location and it provides less locations for a security breach. It is also more secure since it may reside in a payment processing network 40 which is typically a private network segment used for very secure and private financial transactions.

In a centralized system the request broker 50 with the central cache 55 is a single logical instance which may be either a single physical instance or redundant depending on the required service levels. In a distributed system the request broker 50 with the central cache 55 can be multiple logical instances. In one version of either the centralized or distributed system, the request broker 50 with the central cache 55 can be logically distributed (e.g., on a regional basis) to improve large scale deployment performance and availability.

The medical institution 60 may be a hospital, pharmacy, laboratory, insurance carrier, health care provider, etc. that is a data source for patient records and information.

The payment processing network 40 is a secure network area which is typically a private network segment. It may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. The payment processing network 40 may use any suitable wired or wireless network, including the Internet. Typically this type of payment processing network is used for secure financial transactions. Using this type of network for health services information is ideal since transactions relating to patient health information also need to be secure and efficient.

FIG. 1 also shows an issuer 76, consumer 80, portable consumer device 85, acquirer 70, and merchant 78 to demonstrate functionality of a payment processing network 40 for commercial transactions. The acquirer 70 is typically a bank that has a merchant account. The issuer 76 may also be a bank, but it could also be a business entity such as a retail store. Some entities are both acquirers and issuers. The consumer 80 in a commercial transaction context, may be an individual, or an organization such as a business that is capable of purchasing goods or services. The merchant 78 may be an individual or an organization such as a business that is capable of providing goods and services.

In a typical purchase transaction, the consumer 80 purchases a good or service at the merchant 78 using a portable consumer device 85 such as a credit card. The consumer's portable consumer device 85 can interact with an access device such as a POS (point of sale) terminal at the merchant 78. For example, the consumer 80 may take a credit card and may swipe it through an appropriate slot in the POS terminal. Alternatively, the POS terminal may be a contactless reader, and the portable consumer device 85 may be a contactless device such as a contactless card or a mobile phone with a contactless element.

An authorization request message is then forwarded to the acquirer 70. After receiving the authorization request message, the authorization request message is then sent to the payment processing network 40. The payment processing network 40 then forwards the authorization request message to the issuer 76 of the portable consumer device 85.

After the issuer 76 receives the authorization request message, the issuer 76 sends an authorization response message back to the payment processing network 40 to indicate whether or not the current transaction is authorized. The payment processing network 40 then forwards the authorization response message back to the acquirer 70. The acquirer 70 then sends the response message back to the merchant 78.

After the merchant 78 receives the authorization response message, the access device at the merchant 78 may then provide the authorization response message for the consumer 80. The response message may be displayed by the POS terminal, the portable consumer device 85, or may be printed out on a receipt.

At the end of the day, a normal clearing and settlement process can be conducted by the payment processing network 40. A clearing process is a process of exchanging financial details between an acquirer and an issuer to facilitate posting to a consumer's account and reconciliation of the consumer's settlement position. Clearing and settlement can occur simultaneously.

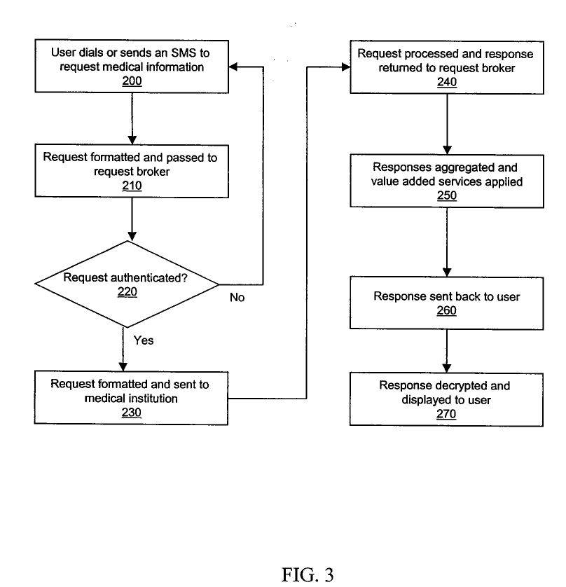

FIG. 3 shows a flowchart including a general method according to an embodiment of the invention. The method can be described with reference to the block diagram in FIG. 1.

First, a consumer 80 may use a portable consumer device 85 to request medical information. For example, a person may get sick while on vacation. He may go to a local doctor for treatment and need to give the doctor information about the last time he had certain relevant tests and blood work done. The doctor's office may be in a small town and remote location where it would take signification time to get copies of the patient's medical records. The patient can use his portable consumer device 85, such as a mobile phone to request his medical records. Another example is where a person has been in a car accident and is severely injured. The person may use a special emergency number to request vital records such as blood type, drug allergies, and current medication by just dialing a number or sending an SMS message so that he can show the EMT the vital information for immediate care. In the alternative the EMT may be able to use her portable consumer device 85, such as a mobile phone or handheld computer to request the vital records.

The user of the portable consumer device may dial a number or send an SMS message to request the specific or general medical information (step 200).

The portable consumer device 85 may comprise a program such as a plug in hereinafter referred to as a device client. The device client may be software which allows the portable consumer device 85 to perform such functions as determining the validity of a medical information request, requesting information from a medical institution 60 through a request broker 50 via a payment processing network 40, and providing security and decryption for responses from medical institutions 60.

A PIN or password may be required to receive the medical information. If a PIN or password is required, the device client may prompt the user for a PIN or password. For example, a message may be displayed on the portable consumer device 85 that says “please enter your password.” In the alternative the request broker 50 may handle the PIN or password request, as described below.

The device client formats the request and connects to the gateway 20 (step 210). The device client and the gateway 20 authenticate each other and the request is then passed to the gateway 20. The request may include the PIN or password entered by the consumer 80 and/or may include information unique to the portable consumer device 85 such as the unique factory-set electronic serial number and telephone number of the phone or the GPS location of the portable consumer device 85.

The gateway 20 receives the request from the portable consumer device 85 and passes the request to the request broker 50 via the payment processing network 40. The request broker 50 may authenticate the requester of the medical information. The request broker 50 may verify the user's identity by sending an authentication request to the portable consumer device 85 (step 220) via the payment processing network 40 and the gateway 20 that asks the user to enter a PIN, a password, or answer a challenge question. For example, the portable consumer device 85 may display a message that says “Please enter your password.” The user then enters his password and the password is sent via the gateway 20 and the payment processing network 40 to the request broker 50.

In the alternative, instead of asking the user for a PIN, password, or to answer a challenge question, the request broker 50 may automatically use unique information from the portable consumer device 85 to authenticate the requester. This may be particularly useful if a person is in a medical emergency situation. For example, a person may be in an accident and need immediate medical assistance. An EMT may arrive on the scene and want to know if she can treat the person with certain life-saving medications but needs to know if the person is allergic to these drugs or is taking medications that may have negative interaction with the life-saving medications. If the person is conscious he may use his portable consumer device 85 to request the vital medical records such as allergies with just a dial of a number or a short SMS. In the alternative the EMT may be able to look get the person's name off of his driver license and use this information to send a request from her portable consumer device such as a mobile phone or handheld computer. In such a situation there may not be time to enter a PIN, password or to answer a challenge question or the person may not be conscious or remember the PIN or password or the answer to the challenge question.

The request broker 50 receives the request for medical information and then sends an authentication request message to the issuer 76 of the portable consumer device 85 via the payment processing network 40 that includes either the PIN or password, the answer to the challenge question, the unique factory-set electronic serial number and telephone number of the portable consumer device 85, the GPS location of the portable consumer device 85 or any combination of these methods. The issuer 76 receives the request and then verifies the PIN or password, verifies the unique factory-set electronic serial number and telephone number of the phone, and/or verifies the GPS location of the phone to ensure it comes from an approved location. The issuer 76 then sends an authentication response message to the request broker 50 via the payment processing network 40 indicating whether or not the requester is authenticated.

If the requester is not authenticated, the request broker 50 sends a message the portable consumer device 85, through the gateway 20, to alert the consumer 80 that authentication failed. For example, a message may be displayed on the portable consumer device 85 that says “Authentication failed.”

If authentication is successful, then the request broker 50 builds a routing map which is a list of medical institutions 60 associated with the patient which may contain patient information. For each medical institution 60 in the routing map, the request broker 50 checks the central cache 55 for a recent match. If there is a recent match then the request broker does not need to request information from that medical institution 60 but instead can use the information already stored in the central cache 55. If there is not a recent match then the request broker 50 formats the request, sends the request to the medical institution 60 (step 230) and waits for a response from the medical institution 60.

If there are no dependencies between requests, asynchronous collection is possible which means that the request broker 50 may receive responses back from the medical institutions 60 in any order. If there are dependencies between requests, synchronous collection is preferred. Instead of receiving the responses from the medical institutions 60 in any order, for each medical institution 60 in the routing map, the request broker may connect to the medical institution 60, send the request and wait for a response. Once the response is received from the medical institution 60 (or if it is timed-out because there is no response), the request broker 50 drops the session and processes the next medical institution 60 until each one has been processed.

If the request broker 50 does not receive a response from the medical institution 60 in an allotted period of time (e.g., a few seconds), the request times out and a new request is formatted and sent. If an alternative source is available, the alternative source is queried. After a number of tries (e.g., three tries), the request broker 50 stops making a request to the medical institution 60, a “Not-Available” place holder is supplied for the missing data and processing continues.

The medical institution 60 receives the request for information, processes the request and then passes back a response to the request broker 50 (step 240).

Once the request broker 50 receives all of the responses back from the medical institutions 60 (in either an asynchronous or synchronous collection), it stores the responses in the central cache 55 and aggregates the responses (step 250). The request broker 50 can handle various types of responses. For example, the responses may be opaque which means that the request broker does not have visibility into the contents of the response. An opaque response may also be encrypted. If the response is not opaque, the request broker 50 may also apply value added services to the response (step 250). Value added services may be edits, augmentation, and/or normalization. The response is sent to the gateway 20 which passes the response to the device client on the portable consumer device 85 (step 260). The device client receives the response, decrypts any opaque segments and presents the data to the consumer 80 (step 270), which is displayed on the portable consumer device 85.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

What is claimed is:

1. A method comprising:
receiving an authentication response message indicating that a requester is authorized to receive medical information;
collecting medical information from various medical institutions via a payment processing network;
storing the collected medical information at a central location; and
providing specific medical information to the requester from the stored collected medical information.

2. The method of claim 1 wherein medical information includes patient information, medical history, medical records, laboratory results, x-ray results, radiology reports, medical problem lists, prescription information, allergies, blood type, immunization history, clinical notes and insurance information and coverage.

3. The method of claim 1 wherein medical institutions include hospitals, pharmacies, laboratories, insurance carriers, and provider offices.

4. The method of claim 1 wherein the payment processing network is configured to process credit cards and financial transactions.

5. The method of claim 1 wherein a requester includes a user of a portable consumer device.

6. A computer readable medium comprising:
code for receiving an authentication response message indicating that a requester is authorized to receive medical information;
code for collecting medical information from various medical institutions via a payment processing network;
code for storing the collected medical information at a central location; and
code for providing specific medical information to the requester from the stored collected medical information.

7. A server comprising the computer readable medium of claim 6.

8. A system comprising:
means for receiving an authentication response message indicating that a requester is authorized to receive medical information;
means for collecting medical information from various medical institutions via a payment processing network;
means for storing the collected medical information at a central location; and
means for providing specific medical information to the requester from the stored collected medical information.

9. A method comprising:
requesting medical information using a portable consumer device wherein an authentication response message is received indicating that a requester is authorized to receive medical information and the requested medical information is collected from various medical institutions via a payment processing network and stored at a central location; and
receiving the medical information wherein the requested medical information is provided from the stored medical information.

10. The method of claim 9 wherein a portable consumer device includes a mobile phone, personal digital assistant, and pager.

11. A method comprising:
receiving a phone number associated with a request for medical information;
dialing the phone number;
sending the request for medical information to a request broker;
sending authentication information to the request broker; and
receiving medical information.

12. The method of claim 11 wherein the authentication information includes a PIN, password, unique factory-set electronic serial number, telephone number, challenge question answer, GPS location, or any combination thereof.

13. The method of claim 11 wherein medical information includes patient information, medical history, medical records, laboratory results, x-ray results, radiology reports, medical problem lists, prescription information, allergies, blood type, immunization history, clinical notes and insurance information and coverage.

14. A phone comprising:
a processor;
an antenna coupled to the processor; and
a computer readable medium coupled to the processor, the computer readable medium comprising code for receiving a phone number associated with a request for medical information, code for dialing the phone number, code for sending the request for medical information to a request broker, code for sending authentication information to the request broker, and code for receiving medical information.

15. A portable consumer device comprising:
a processor;
a computer readable medium coupled to the processor, wherein the computer readable medium comprises code for receiving a phone number associated with a request for medical information, code for dialing the phone number, code for sending the request for medical information to a request broker, code for sending authentication information to the request broker, and code for receiving medical information.
